(19) United States
(12) Patent Application Publication
(10) Pub. No.: US 2013/0005872 A1
(43) Pub. Date: Jan. 3, 2013

(54) POLYLACTIC ACID RESIN COMPOSITION CONTAINING PHOSPHORUS COMPOUND AND POLYSILOXANE COMPOUND AND MOLDED ARTICLE MADE BY USING THE SAME

(76) Inventors: Yukihiro Kiuchi, Tokyo (JP); Naoki Morishita, Tokyo (JP); Makoto Soyama, Tokyo (JP); Masatoshi Iji, Tokyo (JP)

(21) Appl. No.: 13/634,952

(22) PCT Filed: Dec. 17, 2010
(86) PCT No.: PCT/JP2010/072776

§ 371 Date: Sep. 14, 2012

(30) Foreign Application Priority Data
Mar. 26, 2010 (JP) 2010-072797

(51) Int. Cl. C08L 67/04; C08K 5/5399; C08K 5/523

(52) U.S. Cl. 524/86; 524/152

(57) ABSTRACT

An exemplary embodiment provides a polylactic acid resin composition, which has bleed resistance even if it is used in applications requiring high level impact resistance and flame retardance and can be produced by a simple method, and provides a molded article made by using the same. A polylactic acid resin composition according to the exemplary embodiment contains a phosphorus compound (A), a polylactic acid resin (C) and a polysiloxane compound (B) including a functional group capable of reacting with the polylactic acid resin (C) as essential components. A molded article according to the exemplary embodiment is obtained by molding the polylactic acid resin composition.

### TECHNICAL FIELD

An exemplary embodiment according to the present invention relates to a polylactic acid resin composition containing a phosphorus compound and a polysiloxane compound as essential components and having excellent bleed resistance, and relates to a molded article using the same.

### BACKGROUND ART

Polyhydroxycarboxylic acids including a polylactic acid resin have relatively excellent molding processability, toughness and rigidity, etc. Of them, a polylactic acid resin can be synthesized from a naturally occurring material such as corn and has excellent molding processability, biodegradability, etc. Because of this, a polylactic acid resin has been developed as an environment-conscious resin in various fields. However, although the polylactic acid resin has excellent physical properties, it is inferior in impact resistance and fracture toughness, which are determined with reference to e.g., bend breaking strain and tensile breaking strain, as compared to resins derived from petroleum-materials, such as an acrylonitrile-styrene-butadiene copolymer (ABS) resin. Therefore, it is difficult to use a polylactic acid resin in jacket materials for electric/electronic equipment requiring high-level impact resistance.

Such a resin composition containing a polylactic acid resin, attempts to provide impact resistance have been made to molded articles obtained from. For example, Patent Literature 1 reports that a biodegradable resin composition having excellent impact resistance and suitably used in the fields including electric and electronic equipment is obtained by incorporating a polylactic acid resin and another biodegradable resin as well as a silicone based additive and a lactic acid based polyester. Furthermore, Patent Literature 2 reports that a molded article of a polylactic acid resin having both impact resistance and heat resistance is obtained by incorporating an organic polysiloxane such as silicone oil.

Furthermore, Patent Literature 3 reports that a biodegradable resin composition excellent in impact resistance, flame retardance etc., is obtained by incorporating polylactic acid and a silicone-lactic acid copolymer. Patent Literature 4 reports that a resin composition excellent in flame retardance, heat resistance and mechanical characteristics is obtained by incorporating a flame retardant (100 to 0.5 parts by weight) such as a phosphorus based flame retardant, a nitrogen compound based flame retardant and a silicone based flame retardant and a resin (120 to 0.5 parts by weight) other than polylactic acid to a polylactic acid resin (100 parts by weight).

As another literature, Patent Literature 5 discloses a lactic acid based polymer composition containing an organic silicon compound as a polymer having both impact resistance and heat resistance and an inorganic filler (crystal nucleating agent). Furthermore, Patent Literature 6 discloses a polylactic acid resin composition containing a polyester based block copolymer obtained from a polyhydroxy structural unit and a specific dicarboxylic acid and a diol, polylactic acid and a specific siloxane compound, as a polylactic acid composition having impact resistance, transparency and bleed resistance. Moreover, Patent Literature 7 discloses that a polylactic acid resin composition and a polylactic acid resin molding having both bleed resistance and an excellent molecular weight retention rate are obtained by incorporating a polylactic acid resin, a metal hydrate containing an alkali metal based substance in a content of 0.2 mass % or less, and phosphazene derivative which is one of phosphorus compounds, as essential components.

### CITATION LIST

### Patent Literature

Patent Literature 1: JP2004-161790A
Patent Literature 2: JP11-116786A
Patent Literature 3: JP2004-277575A
Patent Literature 4: JP2004-190026A
Patent Literature 5: JP2004-352908A
Patent Literature 6: JP2007-262200A
Patent Literature 7: WO 2010/004799

### SUMMARY OF INVENTION

### Technical Problem to be Solved by Invention

In the biodegradable resin composition described in Patent Literature 1, however, when a large amount of a silicone based additive is contained, bleed may occur with the passage of time. When the amount of silicone based additive is reduced to overcome this, it becomes difficult to obtain a molded article having impact resistance. The silicone oil used in Patent Literature 2 has a poor compatibility with polylactic acid and bleeds on the surface of a molded article during a molding-forming process or after molding, with the result that the molded article may change in physical properties. It lacks practicality.

With respect to the biodegradable resin composition described in Patent Literature 3, a process for producing a silicone-lactic acid copolymer is complicated. In addition, although it has an excellent flame retardance, impact resistance is insufficient compared to those of conventional resins that have been used for electronic and electric equipment. Thus, the resin composition is disadvantageous from a practical point of view. Also, with respect to the resin composition described in Patent Literature 4, although it has an excellent flame retardance, impact resistance is insufficient compared to those of conventional resins that have been used for electronic and electric equipment. Thus, the resin composition is disadvantageous from a practical point of view.

The molded articles obtained from the compositions described in Patent Literatures 5 and 6 are improved in impact resistance; however, the impact resistance fails to satisfy the level required in the electronic and electric field. With respect to the polylactic acid resin composition described in Patent Literature 7, since the polylactic acid resin and the phosphorus compound significantly differ in polarity, the concentration of a phosphorus compound that can be added is limited. When the phosphorus compound is increased to the addition amount required for attaining both excellent flame retardance and mechanical characteristics such as impact resistance, significant bleeding may occur on the surface of a molding.

Accordingly, it has been required to obtain a polylactic acid resin composition, which can be produced by a simple method and causes no problematic bleeding in applications requiring high-level impact resistance and flame retardance.

A problem of an exemplary embodiment according to the present invention is to provide a polylactic acid resin composition, which can be produced by a simple method and has bleed resistance even in applications requiring high-level impact resistance and flame retardance and to provide a molded article using the same.

### Means For Solving Problem

An exemplary embodiment according to relates to a polylactic acid resin composition containing a phosphorus compound (A), a polylactic acid resin (C) and a polysiloxane compound (B) including a functional group capable of reacting with the polylactic acid resin (C) as essential components.

Furthermore, an exemplary embodiment relates to a molded article obtained by molding the above described polylactic acid resin composition.

### Advantageous Effects of Invention

According to an exemplary embodiment of the present invention, it is possible to manufacture a polylactic acid resin composition having bleed resistance even in applications requiring high level impact resistance and flame retardance, by a simple method and provide a molded article capable of reducing an environment load during a production and disposal processes.

### DESCRIPTION OF EMBODIMENTS

The present inventors have dealt with the case where a phosphorus compound (A) is added in order to provide a molded article containing a polylactic acid resin (C) as a main component with flame retardance and plasticity and conducted intensive studies on a method for improving bleed resistance by improving solubility of the phosphorus compound (A) to the polylactic acid resin (C). As a result, the present inventors has found that a polylactic acid resin composition excellent in bleed resistance can be obtained by adding a polysiloxane compound (B) including a functional group capable of reacting with the polylactic acid resin (C) to a polylactic acid resin (C).

The reason why the polylactic acid resin composition containing a polysiloxane compound (B) including a functional group capable of reacting with a polylactic acid resin (C) has an excellent effect of suppressing bleed out of a phosphorus compound (A) was presumed as follows: Since the polylactic acid resin (C) reacts with the polysiloxane compound (B) to form a polysiloxane-polylactic acid resin copolymer (hereinafter referred to as “polysiloxane modified polylactic acid resin”), the polarity of the polysiloxane modified polylactic acid resin becomes lower than the polarity of the polylactic acid resin (C) and comes closer to the polarity of the phosphorus compound (A), thereby reinforcing the intermolecular interaction between the polysiloxane modified polylactic acid resin and the phosphorus compound (A). As a result, a low molecular weight compound such as the phosphorus compound (A), which is contained in a molding obtained from such a polylactic acid resin composition, become difficult to migrate to the surface of the molding.

More specifically, a case of using a polysiloxane compound (B) including an amino group at a side chain will be described. Basically, since a polylactic acid resin (C) and a phosphorus compound (A) significantly differ in polarity, the polylactic acid resin (C) and the phosphorus compound (A) cause phase separation under high temperature and high humidity conditions. Consequently, the phosphorus compound (A) tends to bleed out in the surface of a molding, etc. In contrast, a polysiloxane compound (B) including an amino group at a side chain reacts with an ester group of the polylactic acid resin (C) to produce a polysiloxane modified polylactic acid resin via an amide bond. The polarity of the polysiloxane modified polylactic acid resin is lower than that of the polylactic acid resin (C) and close to the polarity of the phosphorus compound (A). Thus, the affinity of the phosphorus compound (A) for the polylactic acid resin (C) containing the polysiloxane modified polylactic acid resin as a main component increases. In other words, since intermolecular interaction such as hydrogen bonding works between the polylactic acid resin (C) having a polysiloxane segment introduced therein and the phosphorus compound (A), bleed out of the phosphorus compound (A) is suppressed. Therefore, it is considered that the molded article using a polylactic acid resin composition according to the exemplary embodiment of the present invention has excellent bleed resistance.

Furthermore, in the polylactic acid resin composition as mentioned above, both a silicone modified polylactic acid resin and an unmodified polylactic acid resin (C) are plasticized by a phosphorus compound (A). In addition to this effect, a polysiloxane compound (B) including a functional group capable of reacting with the polylactic acid resin (C) is finely dispersed. Both effects synergistically work to significantly improve impact resistance as compared to the cases where a phosphorus compound (A) alone and the polysiloxane compound (B) alone are added to the polylactic acid resin (C). In addition, flame retardance is improved by the effect of the phosphorus compound (A).

Examples of a polylactic acid resin (C) which is the main component of the polylactic acid resin composition according to the exemplary embodiment, may include polylactic acid resin extracts obtained from biomass feedstock, derivatives or modified compounds of these; monomers and oligomers of lactic acid based compounds obtained from biomass feedstock or condensation polymerized products synthesized from the derivatives or modified compounds of these; and segments of polylactic acid resins synthesized from materials other than biomass feedstock. For example, a polylactic acid resin represented by Formula (3) below can be mentioned.

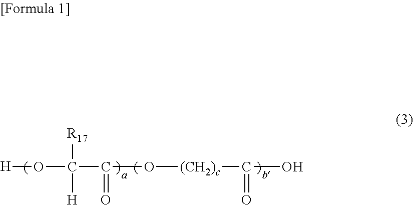

In Formula (3), R₁₇ represents an alkyl group having 18 carbon atoms or less; a and c each represent an integer beyond 0; b′ represents an integer of 0 or more. a is preferably integer of 500 or more and 13000 or less, and more preferably, 1500 or more and 4000 or less. b′ is preferably integer of 5000 or less, including 0. c is preferably integer of 1 or more and 50 or less. In a polylactic acid resin represented by Formula (3), each of the repeat units shown with the repeat-unit numbers a and b′ may be continuously connected or alternately repeated.

Specific examples of a polylactic acid resin represented by Formula (3) may include polymers of L-lactic acid, D-lactic acid and derivatives of these and copolymers containing these as a main component. Examples of the copolymers may include copolymers obtained by copolymerizing L-lactic acid, D-lactic acid or a derivative of these with one type or two types or more of e.g., glycolic acid, polyhydroxybutyric acid, polycaprolactone, polybutylene succinate, polyethylene succinate, polybutylene adipate terephthalate, polybutylene succinate terephthalate and polyhydroxyalkanoate. Of these, in view of saving petroleum resources, resins using vegetable-derived materials as raw materials are preferable. In view of heat resistance and moldability, poly(L-lactic acid), poly(D-lactic acid) and a copolymer of these are more preferable. Furthermore, the melting point of the polylactic acid resin containing poly(L-lactic acid) as a main component varies depending upon the ratio of a D-lactic acid component; however, in consideration of mechanical characteristics and heat resistance of a molded article, the polylactic acid resin preferably has the melting point of 160° C. or more.

The weight average molecular weight of a polylactic acid resin (C) is preferably 30,000 to 1,000,000 and more preferably 100,000 to 300,000.

A polylactic acid resin (C) can be produced by a melt polymerization method, and also produced further in combination with a solid phase polymerization method. As a method for controlling the melt flow rate of a polylactic acid resin (C) within a predetermined range, when the melt flow rate is excessively large, a method of increasing the molecular weight of the resin can be used by use of a small amount of chain extender, such as a diisocyanate compound, a carbodiimide compound, an epoxy compound and an acid anhydride. When the melt flow rate is excessively low, a method of mixing a biodegradable polyester resin and a low molecular weight compound having a large melt flow rate, can be used.

A polylactic acid resin composition according to the exemplary embodiment contains a phosphorus compound (A) as an essential component. The phosphorus compound (A) is a component providing the polylactic acid resin composition with flame retardance. As the phosphorus compound (A), a phosphorus based flame retardant can be used. Specific examples thereof may include a phosphazene derivative, an aromatic condensed phosphoric ester and a phosphophenanthrene or a derivative thereof. Specific examples of the phosphazene derivative may include cyclic phosphazene compounds such as a cyclic phosphazene compound having a configuration in which a phenoxy group is bound to a phosphorus atom, a cyclic phosphazene compound in which a phenoxy group binding to a phosphorus atom has a hydroxy group, a cyclic phosphazene compound in which a phenoxy group binding to a phosphorus atom has a cyano group, and a cyclic phosphazene compound in which a phenoxy group binding to a phosphorus atom has a methoxy group. Specific examples of the aromatic condensed phosphoric ester may include resorcinol polyphenyl phosphate, resorcinol poly(di-2,6-xylyl)phosphate, bisphenol A polycresyl phosphate, hydroquinone poly(2,6-xylyl)phosphate and condensates of these. Specific examples of the phosphophenanthrene or a derivative thereof may include phosphophenanthrene, a derivative of phosphophenanthrene in which a hydrogen atom binding to a phosphorus atom is replaced with hydroquinone, a derivative of phosphophenanthrene in which a hydrogen atom binding to a phosphorus atom is replaced with a benzyl group, a derivative of phosphophenanthrene in which a hydrogen atom binding to a phosphorus atom is replaced with an aliphatic ester derivative (manufactured by Sanko Co., Ltd., trade name: M-Ester) and a derivative of phosphophenanthrene in which a hydrogen atom binding to a phosphorus atom is replaced with an aliphatic ester derivative and polymerized, having a weight average molecular weight of 3,000 to about 10,000 (manufactured by Sanko Co., Ltd., trade name: ME-P8).

The use amount of a phosphorus compound (A), in view of maintaining balance between impact resistance, flame retardance and bleed resistance, is preferably 1 part by mass or more and 20 parts by mass or less and more preferably 5 parts by mass or more and 15 parts by mass or less based on 100 parts by mass which is the total of a polysiloxane compound (B) and a polylactic acid resin (C).

A polylactic acid resin composition according to the exemplary embodiment contains a polysiloxane compound (B) including a functional group capable of reacting with a polylactic acid resin (C) as an essential component. Examples of the functional group capable of reacting with a polylactic acid resin (C) may include an amino group, an epoxy group, a methacryl group, a hydroxy group, an alkoxy group and a carboxyl group. These polysiloxane compounds (B) may be used in combination.

The polysiloxane compound (B) including a functional group capable of reacting with a polylactic acid resin (C) has, as a basic skeleton, at least a configuration in which organo siloxane units are bound linearly or in branched form. Examples of the structural unit to be bound to a silicon atom other than the functional group capable of reacting with a polylactic acid resin (C) may include an alkyl group having 18 carbon atoms or less, an alkenyl group having 18 carbon atoms or less, an aryl group'having 18 carbon atoms or less, an aralkyl group having 18 carbon atoms or less and an alkylaryl group having 18 carbon atoms or less. Examples of the alkyl group may include a methyl group, an ethyl group, a propyl group, a butyl group and a t-butyl group. Examples of the alkenyl group may include a vinyl group. Examples of the aryl group may include a phenyl group and a naphthyl group. Examples of the aralkyl group may include a benzyl group. Examples of the alkylaryl group may include those obtained by replacing at least one of hydrogen atoms of e.g., a phenyl group and a naphthyl group with a methyl group, an ethyl group, a propyl group, a butyl group, t-butyl group and the like. Furthermore, whole or part of hydrogen atoms which these have may be replaced with a halogen atom such as chlorine, fluorine and bromine. Examples of the group replaced with a halogen atom may include a chloromethyl group, a 3,3,3-trifluoromethyl group, a perfluorobutyl group and a perfluorooctyl group. Of them, any one of a methyl group, a phenyl group and a polyether group is preferable. Examples of the polyether group herein may include a polyoxyalkylene group having 1 to 50 repeat units; however a polyoxyethylene group, a polyoxypropylene group or a residue of a copolymer containing both of them is preferable.

In the exemplary embodiment, as the functional group capable of reacting with a polylactic acid resin (C), a polysiloxane compound (B) having an amino group (hereinafter, particularly referred to as “polysiloxane compound (B1)”) is preferably used. The polysiloxane compound (B1) reacts with an ester group of the segment of a polylactic acid resin (C) to form the segment of the polysiloxane compound (B1), which is bound to the polylactic acid resin (C) via an amide bond. Because of this, the segment of the polysiloxane compound (B1) is suppressed from separating and bleeding out from a molded article, with the result that a molded article having high impact strength can be formed.

In the exemplary embodiment, as the polysiloxane compound (B), a compound including an amino group as a functional group capable of reacting with a polylactic acid resin (C) at a side chain is preferably used. That is, the amino group is preferably positioned at a side chain of a polysiloxane skeleton. The amino group positioned at a side chain of a polysiloxane skeleton has a high degree of freedom as compared to an amino group positioned at an end of the main chain of the polysiloxane skeleton and easily reacts with the segment of a polylactic acid resin (C). Thus, the above effect can be significantly obtained. As such a compound, for example, compounds represented by Formula (1) below may be mentioned.

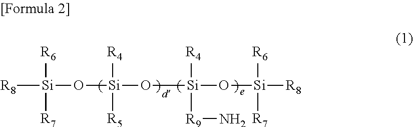

Furthermore, in the exemplary embodiment, as the polysiloxane compound (B), for example, a compound including, as a functional group capable of reacting with a polylactic acid resin (C), an amino group forming a diamino structure at an end or a position of a side chain can be used. More specifically, as long as the amino group forms a diamino structure, the amino group is preferably positioned not only at a side chain of a polysiloxane skeleton but also at an end of the polysiloxane skeleton. The amino group forming a diamino structure has a high degree of freedom as compared to an amino group forming no diamino structure. Thus, even if it is positioned at an end of the main chain of a polysiloxane skeleton, it easily reacts with the segment of a polylactic acid resin (C) and thus the above effect can be significantly obtained. As such a compound, for example, compounds represented by Formula (2) below may be mentioned.

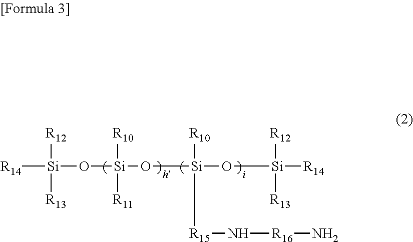

In Formulas (1) and (2), R₄ to R₈ and R₁₀ to R₁₄ each independently represent an alkyl group having 18 carbon atoms or less, an alkenyl group having 18 carbon atoms or less, an aryl group having 18 carbon atoms or less, an aralkyl group having 18 carbon atoms or less, an alkylaryl group having 18 carbon atoms or less, or —(CH₂)_{α}—NH—C₆H₅ (α represents any one integer of 1 to 8). Examples of the alkyl group may include a methyl group, an ethyl group, a propyl group, a butyl group and a t-butyl group. Examples of the alkenyl group may include a vinyl group. Examples of the aryl group may include a phenyl group and a naphthyl group. Examples of the aralkyl group may include a benzyl group. Examples of the alkylaryl group may include those obtained by replacing at least one of the hydrogen atoms of, e.g., a phenyl group and a naphthyl group with a methyl group, an ethyl group, a propyl group, a butyl group, a t-butyl group and the like. Furthermore, whole or part of hydrogen atoms which these have may be replaced with a halogen atom such as chlorine, fluorine and bromine. Examples of the group replaced with a halogen atom may include a chloromethyl group, a 3,3,3-trifluoromethyl group, a perfluorobutyl group and a perfluorooctyl group. R₄ to R₈ and R₁₀ to R₁₄ are each preferably any one of a methyl group, a phenyl group and a polyether group. As the polyether group herein, a polyoxyalkylene group having 1 to 50 repeat units may be mentioned; however preferably a polyoxyethylene group, a polyoxypropylene group or a residue of a copolymer containing both of them. R₄ to R₈ and R₁₀ to R₁₄ may be the same or different from each other.

Since a phenyl group has a function of improving transparency of the segment of a polysiloxane compound (B), the refractive index of a polysiloxane modified polylactic acid resin can be controlled by controlling the content of a phenyl group in the polysiloxane compound (B). By matching the refractive index of the segment of a polysiloxane compound (B) with the refractive index of the segment of a polylactic acid resin (C), a molded article can have a uniform refractive index and a desired degree of transparency can be provided with the molded articles.

In Formulas (1) and (2), each of R₉, R₁₅ and R₁₆ independently represents a divalent organic group. Examples of the divalent organic group may include an alkylene group such as a methylene group, an ethylene group, a propylene group and a butylene group; an alkylarylene group such as a phenylene group and a tolylene group; an oxyalkylene group or a polyoxyalkylene group such as —(CH₂—CH₂—O)_{b}— (b represents an integer of 1 to 50), —[CH₂—CH(CH₃)—O]_{c}— (c represents an integer of 1 to 50); and —(CH₂)_{d}—NHCO— (d represents an integer of 1 to 8). R₁₆ is preferably an ethylene group, and each of R₉ and R₁₅ are preferably a propylene group.

In Formulas (1) and (2), d′ and h′ each independently represent an integer of 0 or more; and, e and i each independently represent an integer beyond 0. d′ and h′ are each preferably integers of 1 or more and 15,000 or less, more preferably integers of 1 or more and 400 or less, and further preferably integers of 1 or more and 100 or less. e and i are each preferably integers of 1 or more and 15,000 or less and preferably an integer attaining a preferable range of average content R₁ of an amino group in a polysiloxane compound (B1) later described. These values preferably have an average value such that the number average molecular weight of a polysiloxane compound (B) falls within the range later described.

In the structures shown in Formula (1) and Formula (2), as for the repeat units shown with the repeat-unit numbers d′, h′, e and I, the same repeat units may be continuously connected, alternately connected or randomly connected.

The average content R₁ of an amino group in a polysiloxane compound (B1) may fall within the range in which the molecular weight of the polysiloxane compound (B1) increases while maintaining reactivity with the segment of a polylactic acid resin (C) and the volatility of the polysiloxane compound (B1) during a production process is suppressed. R₁ is preferably 0.01 mass % or more and 2.5 mass % or less, and more preferably, 0.01 mass % or more and 1.0 mass % or less. When R₁ is 0.01 mass % or more, an amide bond can be sufficiently formed between the amino group and the segment of a polylactic acid resin (C), and thus, the polylactic acid resin (C) can be effectively formed. Furthermore, in a molded article, bleed out caused by separation of the segment of a polysiloxane compound (B1) can be suppressed. When R₁ is 2.5 mass % or less, hydrolysis of a polylactic acid resin (C) during a production process is suppressed; at the same time, a molded article having a high mechanical strength and uniform composition can be obtained while suppressing aggregation.

The average content R₁ (mass %) of an amino group in a polysiloxane compound (B1) can be obtained by Formula (4a) below.

R₁(mass %)=(16/amino equivalent)×100 (4a)

In Formula (4a), the “amino equivalent” is an average value of mass of a polysiloxane compound (B1) per mole of an amino group. In the case of a polysiloxane compound (B) containing no amino group, R₁ is 0 mass %.

Furthermore, the average content R₂ of an amino group based on the total of a polysiloxane compound (B) and a polylactic acid resin (C) is preferably beyond 50 mass ppm to less than 250 mass ppm. When R₂ is beyond 50 mass ppm to less than 250 mass ppm, excellent bleed resistance of a molded article can be attained. In contrast, when R₂ is 50 mass ppm or less, the polarity of a polysiloxane modified polylactic acid resin becomes excessively low, with the result that the bleed resistance of a phosphorus compound (A) may become insufficient. Furthermore, when R₂ is 250 mass ppm or more, the polarity of a polysiloxane modified polylactic acid resin becomes excessively high, with the result that the bleed resistance of a phosphorus compound (A) may become insufficient.

The average content R₂ (mass ppm) of an amino group based on the total of a polysiloxane compound (B) and a polylactic acid resin (C) can be obtained by Formula (5) below.

R₂(mass ppm)=R₁(mass %)×W(mass %)×100 (5)

In the formula, W represents the mass ratio (mass %) of a polysiloxane compound (B) based on the total of a polysiloxane compound (B) and a polylactic acid resin (C).

A polysiloxane compound (B1) is preferably one which easily binds to the segment of a polylactic acid resin (C) under mild conditions without using a special means.

The number average molecular weight of a polysiloxane compound (B1) is preferably 900 or more and 120,000 or less, more preferably, 900 or more and 30,000 or less and further preferably 900 or more and 8,000 or less. When the number average molecular weight of a polysiloxane compound (B1) is 900 or more, in a production process of a polysiloxane modified polylactic acid resin, a loss due to volatilization in kneading with a molten polylactic acid based compound can be suppressed. When the number average molecular weight is 120,000 or less, dispersibility is excellent and a uniform molded article can be obtained.

As the number average molecular weight of a polysiloxane compound (B), a measurement value measured by GPC (corrected by a polystyrene reference sample) analysis of a 0.1% chloroform solution of a sample, can be employed.

A polysiloxane compound (B1) can be produced in accordance with the description of Silicone Handbook (issued by The Nikkan Kogyo Shimbun, Ltd., p. 165) etc. A polysiloxane compound (B1) including an amino group at a side chain can be synthesized by use of a siloxane oligomer, which is obtained through hydrolysis of aminoalkylmethyl dimethoxysilane, cyclic siloxane and a basic catalyst. Furthermore, a polysiloxane compound (B1) including an amino group at both ends can be obtained by using bis(aminopropyl)tetramethyl disiloxane, cyclic siloxane and a basic catalyst. Furthermore, a partially condensed siloxane compound is formed by dissolving an appropriate amount of partially hydrolyzed condensate of diorganodichlorosilane in an organic solvent depending upon a molecular weight of a siloxane compound component and the ratios of M units and D units constituting the siloxane compound; and adding water to perform hydrolysis. Further, a triorganomonochlorosilane is added to the partially condensed siloxane compound, to react these compound. After completion of polymerization, a solvent is separated by distillation etc., to obtain a polysiloxane compound (B1).

In the exemplary embodiment, a polysiloxane compound (B) including an epoxy group (hereinafter, particularly referred to as a “polysiloxane compound (B2)”) as a functional group capable of reacting with a polylactic acid resin (C), can be also used. Furthermore, a polysiloxane compound (B1) and a polysiloxane compound (B2) can be also used in combination. As the polysiloxane compound (B2), for example, compounds represented by Formulas (6) to (9) below may be mentioned.

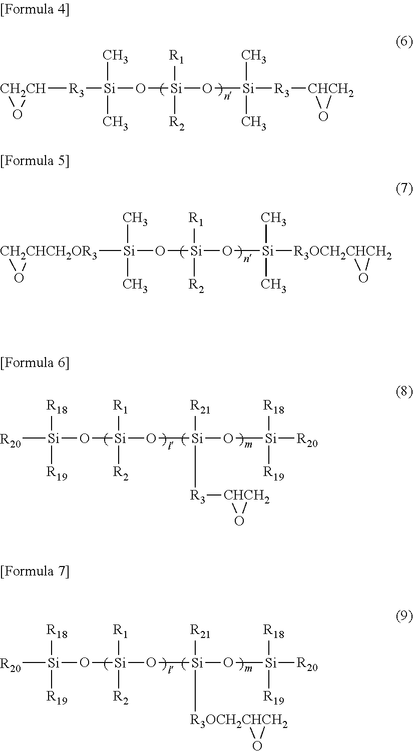

In Formulas (6) to (9), R₁, R₂ and R₁₅ to R₂₁ each independently represent an alkyl group having 18 carbon atoms or less, an alkenyl group having 18 carbon atoms or less, an aryl group having 18 carbon atoms or less, an aralkyl group having 18 carbon atoms or less, an alkylaryl group having 18 carbon atoms or less, or —(CH₂)_{α}—NH—C₆H₅ (α represents any one integer of 1 to 8); whole or part of the hydrogen atoms which these have may be replaced with a halogen atom; R₃ represents a divalent organic group; 1′ and n′ each independently represent an integer of 0 or more; and m represents an integer beyond 0.

As the alkyl group, alkenyl group, aryl group, aralkyl group, alkylaryl group and —(CH₂)_{α}—NH—C₆H₅ represented by R₁, R₂ and R₁₈ to R₂₁, for example, the same as those represented by R₄ in Formula (1) may be mentioned. As the divalent organic group represented by R₃, for example, the same as those represented by R₉ in Formula (1) may be mentioned. Furthermore, in the structures shown in Formulas (6) to (9), as for the repeat units represented by repeat-unit numbers l′, m and n′, respectively, the same repeat units may be continuously connected, alternately repeated or randomly connected.

Furthermore, in a polysiloxane compound (B2), the average content R₂ (mass %) of an epoxy group is preferably less than 2 mass %. When R₂ is set to be less than 2 mass %, the reaction with a polysiloxane compound (B1) can be controlled to form an appropriately crosslinked elastomer, with the result that molded article improved in mechanical characteristics can be obtained.

The average content R₂ (mass %) of an epoxy group in a polysiloxane compound (B2) can be obtained in accordance with Formula (4b) below.

R₂(mass %)=(43/epoxy equivalent)×100 (4b)

In Formula (4b), the “epoxy equivalent” refers to an average value of mass of a polysiloxane compound (B2) per mole of an epoxy group. In the case of a polysiloxane compound (B) containing no epoxy group, R₂ is 0 mass %.

For the same reasons in production as in a polysiloxane compound (B1), the number average molecular weight of a polysiloxane compound (B2) is preferably 900 or more and 120,000 or less.

A polysiloxane compound (B2) can be produced in accordance with the description of Silicone Handbook (issued by The Nikkan Kogyo Shimbun, Ltd., p. 164) etc. More specifically, an unsaturated epoxy compound such as dimethyl polysiloxane including an Si—H group and allylglycidyl ether is subjected to an addition reaction in the presence of a platinum catalyst to obtain a polysiloxane compound (B2).

Also, in the exemplary embodiment, a polysiloxane compound (B) including, as a functional group capable of reacting with a polylactic acid resin (C), a methacryl group, a hydroxy group, an alkoxy group or a carboxyl group can be used.

In the exemplary embodiment, it is possible to use a polysiloxane modified polylactic acid resin, which is obtained by modifying a polylactic acid resin (C) with a polysiloxane compound (B) including a functional group capable of reacting with the polylactic acid resin (C). As the polysiloxane compound (B), a polysiloxane compound (B1) is preferably used, and a polysiloxane compound (B1) including an amino group at a side chain is, more preferably used. At this time, as long as the function of a polysiloxane compound (B1) including an amino group at a side chain is not inhibited, a polysiloxane compound (B1) including an amino group at an end of the main chain and a polysiloxane compound (B) including no amino group such as a polysiloxane compound (B2) including an epoxy group can be also used in combination. The contents of the polysiloxane compound (B1) including an amino group at an end of the main chain and the polysiloxane compound (B) containing no amino group are preferably 0 mass % or more and 5 mass % or less based on the total of the polysiloxane compound (B) and the number average molecular weight thereof is preferably 900 or more and 120,000 or less.

In a method for producing a polysiloxane modified polylactic acid resin modified with a polysiloxane compound (B1) including an amino group, the mixture is obtained by blending a polysiloxane compound (B1) and a polylactic acid resin (C) so as to satisfy a predetermined ratio of an amino group to the polylactic acid resin (C), and then the mixture is mixed and stirred while applying shearing force in a molten state, to obtain the polysiloxane modified polylactic acid resin. Furthermore, in a method for producing a polysiloxane modified polylactic acid resin modified with a polysiloxane compound (B1) including an amino group and a polysiloxane compound (B2) including an epoxy group, a polysiloxane compound (B1), a polysiloxane compound (B2) and a polylactic acid resin (C) may be simultaneously added, mixed and stirred; however, it is preferable that the reaction between a polysiloxane compound (B1) and a polylactic acid resin (C) is first carried, out and then the reaction between the resultant material and a polysiloxane compound (B2) is carried out.

To apply shearing force to a molten polylactic acid resin (C) and a polysiloxane compound (B), for example, an apparatus such as a roll, an extruder, a kneader and a batch kneading machine equipped with a reflux apparatus can be used. As the extruder, one having a single screw or a multi screw with a vent is preferably employed because it is easy to supply raw materials and take out a product. The melt-shearing temperature is preferably not less than the melt flow temperature of a polylactic acid resin (C) which is a raw material, and more preferably higher by 10° C. or more than the melt flow temperature and preferably not more than the decomposition temperature of a polylactic acid resin (C) which is a raw material. The melt shearing time is preferably 0.1 minutes or more and 30 minutes or less, and more preferably 0.5 minutes or more and 10 minutes or less. When the melt shearing time is 0.1 minutes or more, the reaction between a polylactic acid resin (C) and a polysiloxane compound (B) is sufficiently carried out. When the melt shearing time is 30 minutes or less, the decomposition of the resultant polysiloxane modified polylactic acid resin can be suppressed.

In a method for producing a polysiloxane modified polylactic acid resin modified with a polysiloxane compound (B2) including an epoxy group, the mixture can be obtained by blending, with a polysiloxane compound (B2) and a polylactic acid resin (C), a tertiary amine such as 2,4,6-tris(dimethylaminomethyl)phenol as a catalyst so as to satisfy a predetermined ratio of the epoxy group, the polylactic acid resin (C) and the catalyst, and the polysiloxane modified polylactic acid resin is obtained by mixing and stirring the mixture while applying shearing force in a molten state. To apply shearing force to the molten mixture of a polysiloxane compound (B2), a polylactic acid resin (C) and a catalyst such as a tertiary amine, the same method as used in the method for producing a polysiloxane modified polylactic acid resin modified with a polysiloxane compound (B1) mentioned above can be used.

In a method for producing a polysiloxane modified polylactic acid resin modified with a polysiloxane compound (B) including a methacryl group, the mixture can be obtained by blending, with a polysiloxane compound (B) having a methacryl group and a polylactic acid resin (C), an organic peroxide such as a hydroperoxide as a catalyst so as to satisfy a predetermined ratio of the methacryl group, the polylactic acid resin (C) and the catalyst, the polysiloxane modified polylactic acid resin is obtained by and mixing and stirring the mixture while applying shearing force in a molten state. To apply shearing force to the molten mixture of a polysiloxane compound (B) having a methacryl group, a polylactic acid resin (C) and a catalyst such as an organic peroxide, the same method as used in the method for producing a polysiloxane modified polylactic acid resin modified with a polysiloxane compound (B1) mentioned above can be used.

As a method for producing a polysiloxane modified polylactic acid resin modified with a polysiloxane compound (B) including a hydroxy group, an alkoxy group or a carboxyl group, the following methods are mentioned. As for the mixture can be obtained by blending a polysiloxane compound (B) including a hydroxy group or a carboxy group and a polylactic acid resin (C) so as to satisfy a predetermined ratio and it is obtained by subjecting the mixture to transesterification in the presence of an acid or an alkali. Furthermore, As for the mixture can be obtained by blending a polysiloxane compound (B) including an alkoxy group and a polylactic acid resin (C) so as to satisfy a predetermined ratio and it is obtained by subjecting to dealcohlization with the addition of a titanium based catalyst such as butyl titanate. To apply shearing force to the molten mixture of a polysiloxane compound (B) including a hydroxy group, an alkoxy group or a carboxyl group and a polylactic acid resin (C), the same method as used in the method for producing a polysiloxane modified polylactic acid resin modified with a polysiloxane compound (B1) mentioned above can be used.

As the polysiloxane modified polylactic acid resin obtained by modifying a polylactic acid resin (C) with a polysiloxane compound (B), for example, those represented by Formulas (10) to (20) below can be mentioned.

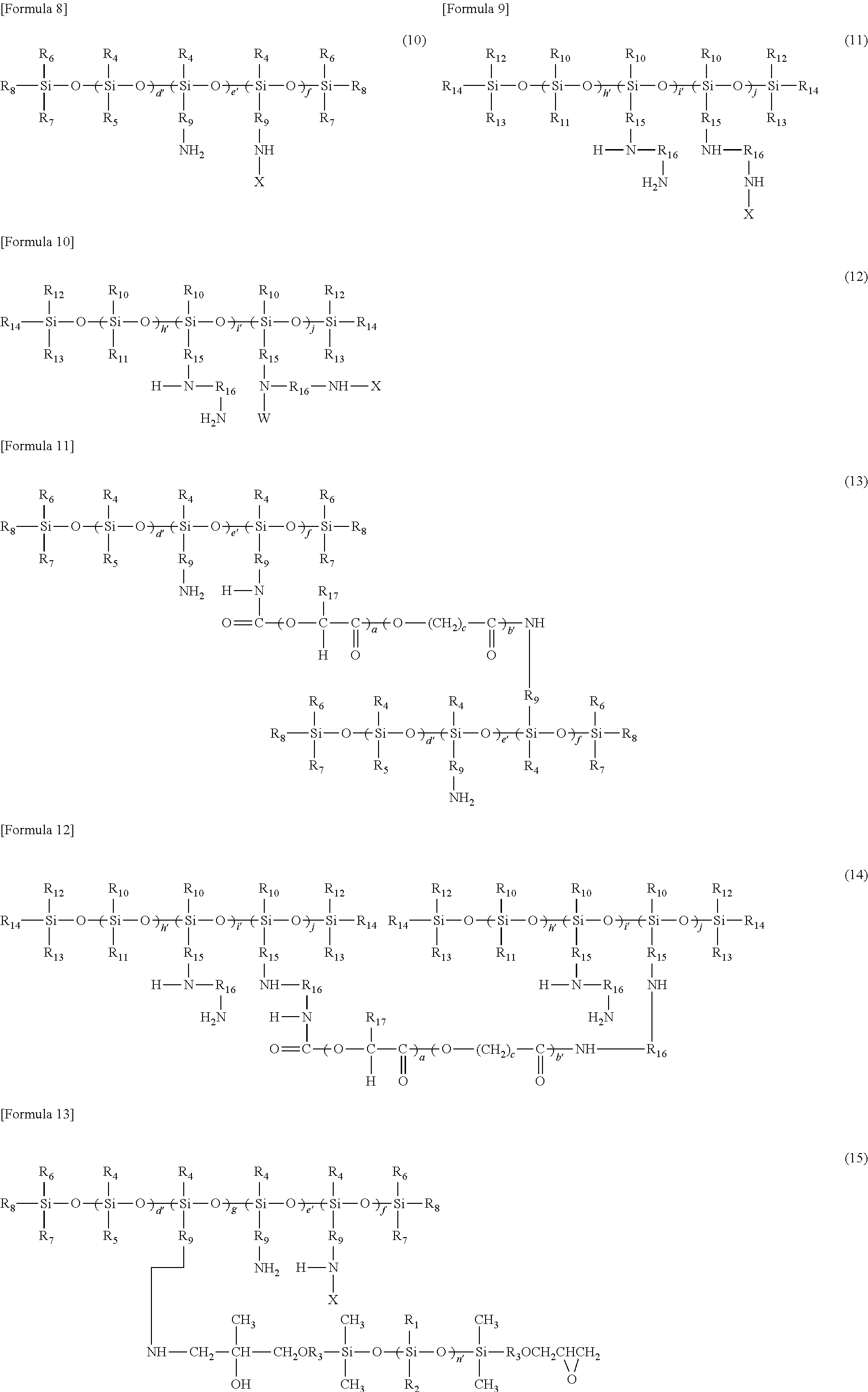

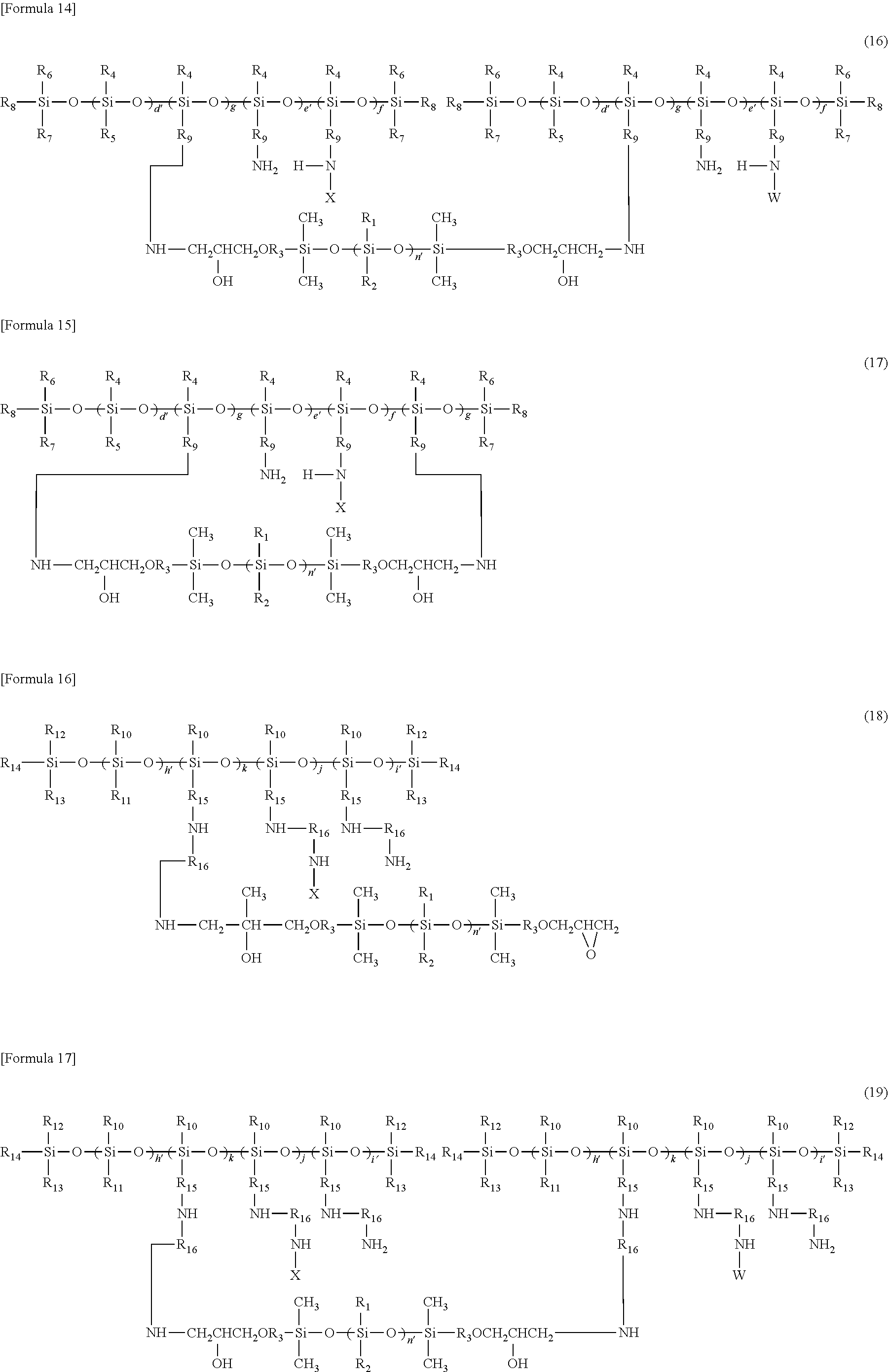

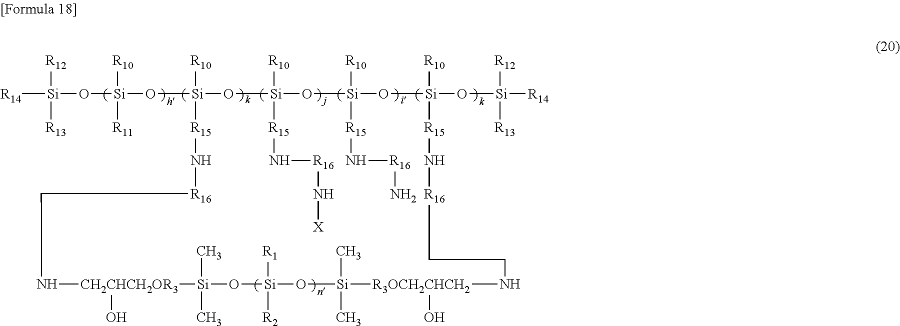

In Formulas (10) to (20), R₁, R₂ and R₄ to R₁₄ each independently represent an alkyl group having 18 carbon atoms or less, an alkenyl group having 18 carbon atoms or less, an aryl group having 18 carbon atoms or less, an aralkyl group having 18 carbon atoms or less, an alkylaryl group having 18 carbon atoms or less, or —(CH₂)_{α}—NH—C₆H₅ (α represents an any integer of 1 to 8); whole or part of the hydrogen atoms which these have may be replaced with a halogen atom; R₃, R₉, R₁₅ and R₁₆ each independently represent a divalent organic group; d′, e′, h′, i′, n′ and b′ each independently represent an integer of 0 or more; f, g, j, k, a and c each independently represent an integer beyond 0; and X and W each independently represent groups represented by Formula (21) below.

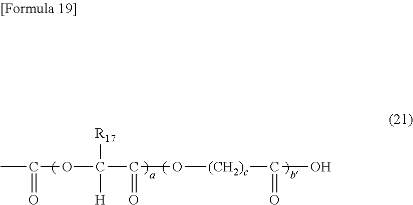

In Formula (21), R₁₇ represents an alkyl group having 18 carbon atoms or less. As the alkyl group, a methyl group is preferable. Furthermore, in Formula (21), b′ represents an integer of 0 or more, and a and c each independently represent an integer beyond 0.

Examples of the alkyl groups, alkenyl groups, aryl groups, aralkyl groups, alkylaryl groups and —(CH₂)_{α}—NH—C₆H₅ which are R₁, R₂ and R₄ to R₁₄ may include the same as those represented by R₄ in Formula (1). Examples of the divalent organic groups which are R₃, R₉, R₁₅ and R₁₆ may include the same as those represented by R₉ in Formula (1). Furthermore, in the structures shown in Formulas (10) to (21), as for the repeat units are separately represented by repeat-unit numbers a, b′, d′, e′, f, g, h′, i′, j, k and n′, the same repeat units may be continuously connected, alternately repeated or randomly connected.

A polylactic acid resin composition according to the exemplary embodiment consequently includes at least one type of polysiloxane modified polylactic acid resin. With a polylactic acid resin composition according to the exemplary embodiment, as long as the function of polysiloxane modified polylactic acid resin is not inhibited, another resin and various types of additives such as a crystal nucleating agent, a heat stabilizer, an antioxidant, a coloring agent, a fluorescence brightener, a filler, a flame retardant, a mold release agent, a softener, an antistatic agent, an impact improver and a plasticizer, may be blended.

Examples of the another resin to be blended with a polylactic acid resin composition include thermoplastic resins such as polypropylene, polystyrene, ABS, nylon, polyethylene terephthalate, polybutylene terephthalate, polycarbonate and alloys of these; thermosetting resins such as a phenol resin, a urea resin, a melamine resin, an alkyd resin, an acryl resin, an unsaturated polyester resin, a diallylphthalate resin, an epoxy resin, a silicone resin, a cyanate based resin, an isocyanate based resin, a furan resin, a ketone resin, a xylene resin, a thermosetting polymido, a thermosetting polyamide, a styrylpyridine based resin, a nitrile-ended resin, an addition curable quinoxaline and an addition curable polyquinoxaline resin; and thermosetting resins using vegetable materials such as lignin, hemicellulose and cellulose. In blending a thermosetting resin, a hardening agent and a hardening accelerator required for a hardening reaction are preferably used.

Of them, a thermoplastic resin having crystallinity is preferably blended with a polylactic acid resin composition. Examples of the thermoplastic resin having crystallinity may include polypropylene, nylon, polyethylene terephthalate, polybutylene terephthalate and alloys with these polylactic acid resins.

In particular, in blending a crystalline resin with a polylactic acid resin composition, a crystal nucleating agent is preferably used for accelerating crystallization of an amorphous content having a low flow initiation temperature in molding into a molded article. The crystal nucleating agent serves by itself as a crystalline nucleus in molding into a molded article to align molecules constituting a resin to form a regular three dimensional structure, resulting in improving moldability of a molded article, reduction in molding time, mechanical strength and heat resistance. Furthermore, since crystallization of an amorphous content is accelerated, even if the mold temperature is high during a molding process, distortion of a molded article is suppressed and mold-release after molding can be easily performed. The same effect can be obtained, even if the mold temperature is higher than the glass transition temperature Tg of a resin.

As the crystal nucleating agent, an inorganic crystal nucleating agent can be used and an organic crystal nucleating agent can be used. Examples of the inorganic crystal nucleating agent include talc, calcium carbonate, mica, boron nitride, synthetic silicic acid, silicate, silica, kaolin, carbon black, zinc flower, montmorillonite, clay mineral, basic magnesium carbonate, quartz powder, glass fiber, glass powder, diatomaceous earth, dolomite powder, titanium oxide, zinc oxide, antimony oxide, barium sulfate, calcium sulfate, alumina, calcium silicate and boron nitride. Examples of the organic crystal nucleating agent include (1) organic carboxylic acids: octyl acid, toluic acid, heptane acid, pelargonic acid, lauric acid, myristic acid, paltimic acid, stearic acid, behenic acid, cerotic acid, montanic acid, melissic acid, benzoic acid, p-tert-butyl benzoic acid, terephthalic acid, monomethyl terephthalate, isophthalic acid, monomethyl isophthalate, rosin acid, 12-hydroxy stearic acid, cholic acid, etc.; (2) an organic carboxylic acid alkali (earth) metal salts: alkali (earth) metal salts of the organic carboxylic acids mentioned above, etc.; (3) polymer organic compounds including a metal salt of a carboxyl group: carboxyl group-containing polyethylenes obtained by oxidation of polyethylene, carboxyl group-containing polypropylenes obtained by oxidation of polypropylene, metal salts such as copolymers of an olefin such as an ethylene, propylene and butene-1, and an acrylic acid or a methacrylic acid, copolymers of styrene and an acrylic acid or a methacrylic acid, copolymers of an olefin and a maleic anhydride, copolymers of styrene and a maleic anhydride, etc.; (4) aliphatic carboxylic acid amides: oleic acid amide, stearic acid amide, erucic acid amide, behenic acid amide, N-oleylpalmitamide, N-stearyl erucic acid amide, N,N′-ethylene-bis-12-hydroxystearyl amide, N,N′-hexamethylene-bis-12-hydroxystearyl amide, N,N′-xylylene-bis-12-hydroxystearyl amide, N,N′-ethylenebis(stearamide), N,N′-methylenebis(stearamide), methylol stearamide, ethylenebisoleic acid amide, ethylenebisbehenic acid amide, ethylenebisstearic acid amide, ethylenebislauric acid amide, hexamethylenebisoleic acid amide, hexamethylenebisstearic acid amide, butylenebisstearic acid amide, N,N′-dioleylsebacic acid amide, N,N′-dioleyladipic acid amide, N,N′-distearyladipic acid amide, N-distearylsebacic acid amide, m-xylylenebisstearic acid amide, N,N′-distearylisophthalic acid amide, N,N′-distearylterephthalic acid amide, N-oleyloleic acid amide, N-stearyloleic acid amide, N-stearylerucic acid amide, N-oleylstearic acid amide, N-stearylstearic acid amide, N-butyl-N′stearyl urea, N-propyl-N′stearyl acid urea, N-allyl-N′ stearyl urea, N-phenyl-N′ stearyl urea, N-stearyl-N′ stearyl urea, dimethylol oil amide, dimethyllauric acid amide, dimethyl stearic acid amide, etc., and N,N′-cyclohexanebis(stearamide), N-lauroyl-L-glutamic acid-α,γ-n-butyramide, etc.; (5) high-molecular weight organic compounds: α-olefins having 5 or more carbon atoms and branched at the 3-position, such as 3,3-dimethylbutene-1,3-methylbutene-1,3-ethylpentene-1,3-methylhexene-1,3,5,5-trimethylhexene-1, and polymers of vinylcycloalkane such as vinylcyclopentane, vinylcyclohexane and vinylnorbornane, polyalkylene glycols such as polyethylene glycol and polypropylene glycol, polyglycolic acid, cellulose, a cellulose ester, a cellulose ether, polyester, polycarbonate etc.; (6) organic compounds of phosphoric acid or phosphorous acid or metal salts thereof: diphenyl phosphate, diphenyl phosphite, bis(4-tert-butylphenyl)sodium phosphate, methylene(2,4-tert-butylphenyl)sodium phosphate, etc.; (7) sorbitol derivatives: bis(p-methylbenzylidene)sorbitol, bis(p-ethylbenzylidene)sorbitol, etc.; (8) cholesterol derivatives: cholesteryl stearate, cholesteryloxystearamide etc.; (9) thioglycolic acid anhydride, paratoluenesulfonic acid, paratoluenesulfonic acid amide and metal salts thereof; (10) phenylphosphonic acid, salts of phenylphosphonic acid with a metal such as zinc, etc.

Of them, since it can suppress hydrolysis of a polylactic acid resin composition, thereby suppressing a decrease in molecular weight, a crystal nucleating agent made of a neutral substance, which does not accelerate hydrolysis of polyester, is preferable. Furthermore, to suppress reduction of molecular weight due to transesterification reaction of a polylactic acid resin composition, rather than a crystal nucleating agent including a carboxy group, an ester and an amide compound which is a derivative thereof, are preferable. Furthermore, a laminar compound such as talc is preferable because it is compatible with a resin or finely dispersed in a resin at a melting state at high temperature during injection molding etc., and precipitates or causes phase separation during a molding and cooling step in a mold, resulting in serving as a crystalline nucleus.

A plurality of the crystal nucleating agents may be used in combination, and an inorganic crystal nucleating agent and an organic crystal nucleating agent can be used in combination. The content of the crystal nucleating agent is preferably 0.1 to 20 mass % in a polylactic acid resin composition.

Examples of the heat stabilizer and the antioxidant include a hindered phenols, phosphorus compounds, hindered amines, sulfur compounds, copper compounds, halides of alkali metals and vitamin E. They are preferably used in an amount within the range of 0.5 parts by mass or less based on 100 parts by mass of the polylactic acid resin (C).

Examples of the filler may include glass beads, glass flake, glass fiber, fibers of plants such as kenaf and bamboo, talc powder, clay powder, mica, Wollastonite powder and silica powder.

Examples of the flame retardant may include metal hydrates such as aluminum hydroxide, a nitrogen based flame retardant and a halogen based flame retardant.

As the impact resistance improver, a softening component can be used. Examples of the softening component may include a polymer block (copolymer) selected from the group consisting of a polyester segment, a polyether segment and a polyhydroxycarboxylic acid segment; a block copolymer obtained by combining a polylactic acid segment, an aromatic polyester segment and a polyalkylene ether segment with one another; a block copolymer formed of a polylactic acid segment and a polycaprolactone segment; a polymer containing an unsaturated carboxylic acid alkyl ester based unit as a main component; an aliphatic polyester such as polybutylene succinate, polyethylene succinate, polycaprolactone, polyethylene adipate, polypropylene adipate, polybutylene adipate, polyhexene adipate and polybutylene succinate adipate; polyethylene glycol and an ester thereof, polyglycerin acetic acid ester, epoxylated bean oil, epoxylated linseed oil, epoxylated linseed oil fatty acid butyl, adipic acid based aliphatic polyester, acetyl tributyl citrate, acetyl ricinoleates, sucrose fatty acid ester, sorbitan fatty acid ester, adipic acid dialkyl ester and alkyl phthalylalkyl glycolate.

As the plasticizer, plasticizers generally used for a polylactic acid resin and an ester based resin, such as a diester based compound consisting of a fatty chain alone and a diester compound including an aromatic group, can be used. Examples of the plasticizer may include benzyl-2-(2-methoxyethoxy)ethyl adipate and a copolymer of triethylene glycol monomethyl ether and succinic acid.

The molded article according to the exemplary embodiment is obtained by molding a polylactic acid resin composition according to the exemplary embodiment. As the molding method, any one of the methods such as injection molding, injection/compression molding, extrusion molding and die molding can be used. Since a molded article excellent in impact resistance and mechanical strength can be obtained, it is preferable to accelerate crystallization in a production process or after a molding process. As a method of accelerating crystallization, the aforementioned methods of using a crystal nucleating agent in the aforementioned range may be mentioned.

Such a molded article is suppressed in denaturation due to bleed for and suitably used for various parts of e.g., electric, electronic equipment and automobiles.

### EXAMPLES

Now, the exemplary embodiment will be further specifically described by way of Examples; however, the technical range according to the exemplary embodiment is not limited to these. Details of raw materials used herein are as follows.

### 1. Phosphorus Compound (a)

As the phosphorus compound (A), phosphorus compounds 1 to 5 shown in Table 1 below were used.

TABLE 1

| | Type | Manufacturer, Trade name |
|---|---|---|
| Phosphorus | Phosphazene | Otsuka Chemical Co., Ltd., |
| compound 1 | derivative* | Trade name: sps-100 |
| Phosphorus | Aromatic condensed | Daihachi Chemical Industry Co., |
| compound 2 | phosphoric ester | Ltd., Trade name: PX-200 |
| Phosphorus | Aromatic condensed | Daihachi Chemical Industry Co., |
| compound 3 | phosphoric ester | Ltd., Trade name; PX-202 |
| Phosphorus | Aromatic condensed | Daihachi Chemical Industry Co., |
| compound 4 | phosphoric ester | Ltd., Trade name: CR-741 |
| Phosphorus | Phosphophenanthrene | Sanko Co., Ltd., Trade name: |
| compound 5 | derivative | ME-P8 |

*Cyclic phosphazene compound including a configuration where a phenoxy group is bound to a phosphorus atom

### 2. Polysiloxane Compound (B)

As the polysiloxane compound (B), polysiloxane compounds 1 to 3 shown in Table 2 below were used.

TABLE 2

| | | Manufacturer, | |
|---|---|---|---|
| | Type | Trades name | Physical property |
| Polysiloxane | Amino group | Dow Corning Toray | Amino group |
| compound 1 | containing | Co., Ltd. Trade | equivalent: 4000 g/eq |
| | type | name: FZ-3705 | Viscosity: 230 mm²/s |
| Polysiloxane | Amino group | Dow Corning Toray | Amino group |
| compound 2 | containing | Co., Ltd, Trade | equivalent: 600 g/eq |
| | type | name: BY-16849 | Viscosity: 1300 mm²/s |
| Polysiloxane | Epoxy group | Shin-Estu Chemical | Epoxy group |
| compound 3 | containing | Co., Ltd. Trade | equivalent: 490 g/eq |
| | type | name: KF-105 | Viscosity: 15 mm²/s |

### 3. Polylactic Acid Resin (C)

As the polylactic acid resin (C), polylactic acid resin 1 (manufactured by Unitika Ltd., trade name: Terramac TE-4000N, melting point: 170° C.) was used.

### 4. Crystal Nucleating Agent

As the crystal nucleating agent, crystal nucleating agent 1 (N,N′-ethylene-bis-12-hydroxystearyl amide, manufactured by Itoh Oil Chemicals Co., Ltd., trade name: ITOHWAX J-530) was used.

### Examples 1 to 8, Reference Examples 1 to 4, Comparative Example 1

A phosphorus compound (A), a polylactic acid resin (C) and a crystal nucleating agent were dry-blended in accordance with the mass ratios shown in Tables 3 to 5. The obtained mixtures each were supplied from a hopper inlet into a continuous kneading extruder having a cylinder temperature set at 190° C. (manufactured by Berstorff GmbH, trade name: ZE40A×40D, L/D=40, screw diameter: φ40). On the other hand, a polysiloxane compound (B) was separately supplied through a vent hole so as to satisfy each of the mass ratios shown in Tables 3 to 5 and the supply rate was controlled such that the total supply amount per hour was 15 to 20 kg/h. The mixture was mixed and stirred under melt-shearing by rotating a screw at a rate of 150 rpm, and thereafter extruded from a dies outlet of the extruder in the form of strand, cooled in water and cut into pellets. In this manner, pellets of the polylactic acid resin composition were obtained.

The obtained pellets were dried at 100° C. for 5 hours and then subjected to an injection molding machine (manufactured by Toshiba Machine Co., Ltd., trade name: EC20P-0.4A, molding temperature: 190° C., mold temperature: 25° C.) to obtain a molding of 125×13×3.2 mm.

### [Evaluation of Bleed Resistance]

Each molding was kept in a thermo-hygrostat of 60° C.×95% RH for 60 hours and then taken out. The surface of each molding was observed by a microscope. Bleed in the surface of each molding was evaluated based on the following criteria. The results are shown in Table 3, Table 4 and Table 5.

◯: No breed was observed in a molding surface.
Δ: Slight breed was observed in a molding surface.
x: Significant breed was observed in a molding surface.

TABLE 3

| | | | | | | Reference | Reference | Comparative |
|---|---|---|---|---|---|---|---|---|
| | | Example 1 | Example 2 | Example 3 | Example 4 | Example 1 | Example 2 | Example 1 |
| Phosphorus | Phosphorus | 10 | 10 | 10 | 10 | 10 | 10 | 10 |
| compound (A) | compound 1 | | | | | | | |
| Polysiloxane | Polysiloxane | 1.5 | 2.0 | 3.0 | 6.0 | 1.0 | 8.0 | |
| compound (B) | compound 1 | | | | | | | |
| Polylactic acid resin | Polylactic acid resin 1 | 98.5 | 98 | 97 | 94 | 99 | 92 | 100 |
| (C) | | | | | | | | |
| Crystal nucleating | Crystal nucleating | 2 | 2 | 2 | 2 | 2 | 2 | 2 |
| agent | agent 1 | | | | | | | |

| | | | | | | | |
|---|---|---|---|---|---|---|---|
| Average content R₂ of amino group | 60 | 80 | 120 | 240 | 40 | 320 | 0 |
| (mass ppm) | | | | | | | |
| Bleed resistance (60° C. × 95RH % × 60H) | ◯ | ◯ | ◯ | Δ | Δ~X | X | Δ~X |

TABLE 4

| | | | Refer- | Refer- | Compar- |
|---|---|---|---|---|---|
| | | Exam- | ence | ence | ative |
| | | ple 3 | Example 3 | Example 4 | Example 1 |
| Phosphorus | Phosphorus | 10 | 10 | 10 | 10 |
| compound | compound 1 | | | | |
| (A) | | | | | |
| Polysiloxane | Polysiloxane | 3.0 | | | |
| compound | compound 1 | | | | |
| (B) | Polysiloxane | | 3.0 | | |
| | compound 2 | | | | |
| | Polysiloxane | | | 3.0 | |
| | compound 3 | | | | |
| Polylactic | Polylactic | 97 | 97 | 97 | 100 |
| acid resin | acid resin 1 | | | | |
| (C) | | | | | |
| Crystal | Crystal | 2 | 2 | 2 | 2 |
| nucleating | nucleating | | | | |
| agent | agent 1 | | | | |

| | | | | |
|---|---|---|---|---|
| Average content R₂ of | 120 | 800 | 0 | 0 |
| amino group (mass ppm) | | | | |
| Bleed resistance (60° C. × | ∘ | x | x | Δ~x |
| 95 RH % × 60H) | | | | |

TABLE 5

| | | | | | | | Comparative |
|---|---|---|---|---|---|---|---|
| | | Example 3 | Example 5 | Example 6 | Example 7 | Example 8 | Example 1 |
| Phosphorus | Phosphorus | 10 | | | | | 10 |
| compound (A) | compound 1 | | | | | | |
| | Phosphorus | | 10 | | | | |
| | compound 2 | | | | | | |
| | Phosphorus | | | 10 | | | |
| | compound 3 | | | | | | |
| | Phosphorus | | | | 10 | | |
| | compound 4 | | | | | | |
| | Phosphorus | | | | | 10 | |
| | compound 5 | | | | | | |
| Polysiloxane | Polysiloxane | 3.0 | 3.0 | 3.0 | 3.0 | 3.0 | |
| compound (B) | compound 1 | | | | | | |
| Polylactic acid | Polylactic acid | 97 | 97 | 97 | 97 | 97 | 100 |
| resin (C) | resin 1 | | | | | | |
| Crystal nucleating | Crystal nucleating | 2 | 2 | 2 | 2 | 2 | 2 |
| agent | agent 1 | | | | | | |

| | | | | | | |
|---|---|---|---|---|---|---|
| Average content R₂ of amino group | 120 | 120 | 120 | 120 | 120 | 0 |
| (mass ppm) | | | | | | |
| Bleed resistance | ◯ | ◯ | ◯ | ◯ | ◯ | Δ~X |
| (60° C. × 95RH % × 60H) | | | | | | |

As shown in Examples 1 to 8, it was found that a polylactic acid resin composition according to the exemplary embodiment is excellent in bleed resistance. In particular, it was found that when an average content R₂ of an amino group based on the total of a polysiloxane compound (B) and a polylactic acid resin (C) is beyond 50 mass ppm and less than 250 ppm, a breed out phenomenon does not occur.

In contrast, it was found that when the average content R₂ of an amino group based on the total of a polysiloxane compound (B) and a polylactic acid resin (C) is 50 mass ppm or less (Reference Example 1) and 250 mass ppm or more (Reference Examples 2 and 3), bleed resistance is inferior. In addition, it was found that also in the case where a polysiloxane compound (B) including an epoxy group was added to a polylactic acid resin (C) without using a catalyst (Reference Example 4), bleed resistance is inferior. This was presumed that since the reactivity of an epoxy group is low, a polysiloxane compound (B) including an epoxy group alone did not form a modified compound with a polylactic acid resin (C).

1. A polylactic acid resin composition comprising a phosphorus compound (A), a polylactic acid resin (C) and a polysiloxane compound (B) including a functional group capable of reacting with the polylactic acid resin (C) as essential components.

2. The polylactic acid resin composition according to claim 1,
wherein the polysiloxane compound (B) includes one or more functional groups selected from an amino group, an epoxy group, a methacryl group, a hydroxy group, an alkoxy group and a carboxyl group, as the functional group capable of reacting with the polylactic acid resin (C).

3. The polylactic acid resin composition according to claim 2,
wherein the polysiloxane compound (B) includes an amino group at a side chain, as the functional group capable of reacting with the polylactic acid resin (C).

4. The polylactic acid resin composition according to claim 3,
wherein the polysiloxane compound (B) is represented by Formula (1) below: 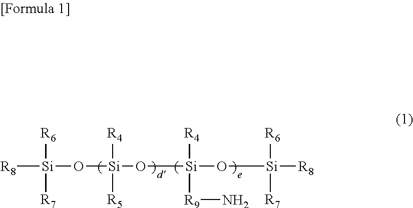
wherein in the Formula (1), R₄ to R₈ each independently represent an alkyl group having 18 carbon atoms or less, an alkenyl group having 18 carbon atoms or less, an aryl group having 18 carbon atoms or less, an aralkyl group having 18 carbon atoms or less, an alkylaryl group having 18 carbon atoms or less, or —(CH₂)_{α}—NH—C₆H₅ where α represents an any integer of 1 to 8, and whole or part of hydrogen atoms which these have may be replaced with a halogen atom; R₉ represents a divalent organic group; d′ represents an integer of 0 or more; and e represents an integer beyond 0.

5. The polylactic acid resin composition according to claim 2,
wherein the polysiloxane compound (B) has an amino group constituting a diamino structure at an end or a position of a side chain, as the functional group capable of reacting with the polylactic acid resin (C).

6. The polylactic acid resin composition according to claim 5,
wherein the polysiloxane compound (B) is represented by Formula (2) below: 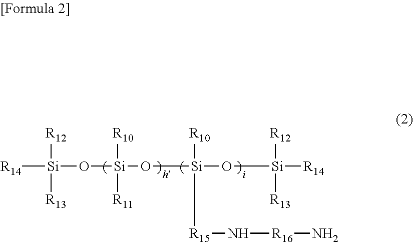
wherein in the Formula (2), R₁₀ to R₁₄ each independently represent an alkyl group having 18 carbon atoms or less, an alkenyl group having 18 carbon atoms or less, an aryl group having 18 carbon atoms or less, an aralkyl group having 18 carbon atoms or less, an alkylaryl group having 18 carbon atoms or less, or —(CH₂)_{α}—NH—C₆H₅ where α represents an any integer of 1 to 8, and whole or part of hydrogen atoms which these have may be replaced with a halogen atom; R₁₅ and R₁₆ each independently represent a divalent organic group; h′ represents an integer of 0 or more; and i represents an integer beyond 0.

7. The polylactic acid resin composition according to claim 3,
wherein an average content of an amino group based on a total of the polysiloxane compound (B) and the polylactic acid resin (C) is beyond 50 mass ppm to less than 250 mass ppm.

8. The polylactic acid resin composition according to claim 1,
wherein the phosphorus compound (A) is one or more selected from a phosphazene derivative, an aromatic condensed phosphoric ester and a phosphophenanthrene or a derivative thereof.

9. A molded article obtained by molding the polylactic acid resin composition according to claim 1.

10. The polylactic acid resin composition according to claim 4,
wherein an average content of an amino group based on a total of the polysiloxane compound (B) and the polylactic acid resin (C) is beyond 50 mass ppm to less than 250 mass ppm.

11. The polylactic acid resin composition according to claim 5,
wherein an average content of an amino group based on a total of the polysiloxane compound (B) and the polylactic acid resin (C) is beyond 50 mass ppm to less than 250 mass ppm.

12. The polylactic acid resin composition according to claim 6,
wherein an average content of an amino group based on a total of the polysiloxane compound (B) and the polylactic acid resin (C) is beyond 50 mass ppm to less than 250 mass ppm.

13. The polylactic acid resin composition according to claim 2,
wherein the phosphorus compound (A) is one or more selected from a phosphazene derivative, an aromatic condensed phosphoric ester and a phosphophenanthrene or a derivative hereof.

14. The polylactic acid resin composition according to claim 3,
wherein the phosphorus compound (A) is one or more selected from a phosphazene derivative, an aromatic condensed phosphoric ester and a phosphophenanthrene or a derivative thereof.

15. The polylactic acid resin composition according to claim 4,
wherein the phosphorus compound (A) is one or more selected from a phosphazene derivative, an aromatic condensed phosphoric ester and a phosphophenanthrene or a derivative thereof.

16. The polylactic acid resin composition according to claim 5,
wherein the phosphorus compound (A) is one or more selected from a phosphazene derivative, an aromatic condensed phosphoric ester and a phosphophenanthrene or a derivative thereof.

17. The polylactic acid resin composition according to claim 6,
wherein the phosphorus compound (A) is one or more selected from a phosphazene derivative, an aromatic condensed phosphoric ester and a phosphophenanthrene or a derivative thereof.

18. The polylactic acid resin composition according to claim 7,
wherein the phosphorus compound (A) is one or more selected from a phosphazene derivative, an aromatic condensed phosphoric ester and a phosphophenanthrene or a derivative thereof.

19. A molded article obtained by molding the polylactic acid resin composition according to claim 2.

20. A molded article obtained by molding the polylactic acid resin composition according to claim 3.
